(19) United States
(12) Patent Application Publication
(10) Pub. No.: US 2009/0039695 A1
(43) Pub. Date: Feb. 12, 2009

(54) GUIDE FRAME FOR GUIDING CONVEYOR SEGMENTS IN HIGH WALL MINING

(75) Inventors: Steven Allen Antoline, Mt. Lookout, WV (US); Paul Emile Van Es, Helvoirt (NL)

Correspondence Address: RENNER OTTO BOISSELLE & SKLAR, LLP, 1621 EUCLID AVENUE, NINETEENTH FLOOR, CLEVELAND, OH, 44115, US

(73) Assignee: Superior Highwall Miners, Inc., Beckley, WV (US)

(21) Appl. No.: 11/814,844

(22) PCT Filed: Feb. 18, 2005
(86) PCT No.: PCT/NL2005/000115

§ 371 Date: Mar. 28, 2008

(51) Int. Cl. B65G 41/00

(52) U.S. Cl. 299/18; 198/860.3

(57) ABSTRACT

The invention relates to a guide frame for use in high wall mining to be located between a launching apparatus and the entrance of a shaft (3) in a high wall (22) and adapted to guide conveyor segments (4) between the launch unit and the shaft, comprising a substantial horizontal supporting guide (5) for supporting the conveyor segments (4). The invention also relates to a method for high wall mining comprising the steps: arranging a launch unit opposite a location of a high wall wherein a shaft is to be excavated, excavating the shaft by a cutter head; and inserting conveyor segments as the cutter head progresses into the high wall.

The invention relates to a guide frame for guiding conveyor segments in high wall mining.

High wall mining is applied in the mining of coal, minerals, ores or other materials in seams or veins under an overburden which may be accessed from an exposed edge of the seam or vein. High wall mining is applicable where the appropriate machinery can be placed in a cut or trench to extend a cutter head, followed by a train of conveyor segments or units as the cutter head advances, into a substantially horizontal oriented shaft under the overburden. The conveyor segments are also known as push beams, as they are pushed into the mine, forming an elongating train of conveyor segments as the cutter head advances. Each conveyor segment normally has auger screw transporters or a conveyor belt to move coal from its lead end to its rear end and further onto the next rearward conveyor segment, and ultimately to the launch unit located outside the entrance of the mine shaft.

Commonly the launch unit (vehicle) is not located directly adjacent to the high wall in which the shaft is excavated, but mainly for reasons of safety at some distance from this high wall. In the prior art the conveyor segments to be inserted into the shaft by the launch unit are conducted over a path of loose material like mine stone, ore and/or coal towards the shaft. This leads to friction and limited control in the positioning of the conveyor segments along the projected theoretically survey-line. The aim of the invention is the provision of means allowing a more controlled movement of the conveyor segments between the launch unit and the shaft.

This aim is reached by a guide frame for use in high wall mining to be located between a launching apparatus and the entrance of a shaft (or the projected entry point of a shaft) in a high wall and adapted to guide conveyor segments between the launch unit and the shaft, comprising a substantial horizontal supporting guide for supporting conveyor segments. To be located between a launching apparatus and the entrance of a shaft means along a theoretically projected survey line between these both locations.

The invention also relates to a method for high wall mining comprising the following steps: arranging a launch unit opposite a location of a high wall wherein a shaft is to be excavated, excavating the shaft by a cutter head and inserting conveyor segments as the cutter head progresses into the high wall, wherein a guide frame is arranged between the high wall and the launch unit before the cutter head starts excavating. With excavating more specifically is meant full gauge excavating in the mine.

The guide frame forms a smooth path for the conveyor segments so that they can be moved (shifted) over the path into the shaft without excessive and uncontrolled forces to be overcome by the launch unit. Herein it is noted that the shaft may reach substantial lengths so that the movement of the conveyor segments within the shaft may require large forces from the launching unit. By reducing the forces needed for transport over the path between launching unit and shaft entrance a larger proportion of the forces generated by the launch unit remains available for transport within the shaft, allowing deeper shafts. Another important advantage is that the position of the cutterhead and the subsequent conveyor segments can fully be controlled and thus the (globe) position and the heading direction of the start of the shaft is well controlled. As the start and the heading direction of the shaft are better controlled with the guide frame and method according the present invention the control of the total heading direction and position of the complete shaft increases. This lead to higher yield and less problems/risks during the mining activities.

A first embodiment provides the feature that the guide frame comprises uprights, that the distance between the uprights in the direction perpendicular to the direction of movement of the conveyor segments is larger than the width of the conveyor segments and that the guide frame comprises a beam connected to the upper cross beams at the ends of the frame. Another embodiment can also provide a beam above the path of the conveyor segments, allowing a crane or hoist to be connected to the beam. The crane may be used for handling these segments for repairs or other handling.

Yet another embodiment provides adjustment means for adjusting the elevation and the tilt of the support guide. Often the shafts are substantially horizontal oriented, due to geological reasons, like the presence of rich seams, may lead to sloping shafts. The sloping may be both in upward and in downward direction. The heading direction in which the shaft is excavated is mainly determined by the heading direction with which the initial part of the shaft is started. Hence is mainly determined by the heading direction of the cutter head when excavation is started. The provisions of this embodiment allow the heading direction of the cutter head to be determined. Consequently the initial direction of the shaft can be determined more accurately. These advantages are also obtained by a method wherein the position of the guide frame is adjusted before excavation starts.

Preferably at each of the comers of the support guide (e.g. a plane) adjustment means have been provided. The guide frame has in the horizontal guide a substantial rectangular shape so that optimal control of the position of the guide can thus be attained.

To allow an easier transport of the guide frame the size of the cross sections of the guide frame over the typical couplings might be equal to the size of the cross section of a standard transport container. This feature allows the guide frame to be transported as a standard container with standardized equipment.

Transport is further eased when the length of the guide frame is a multiple of 10 feet (e.g. 20, 30 or 40 feet). When a guide frame with a length lager than 40 feet is requested the guide frame may be formed by a multiple of units, each having the size of standard container. These guide frame units are preferably provided with coupling means of longitudinally coupling a number of individual units for forming a combined guide frame.

As stated before the conveyor units may extend over a long (over several hundred meters) distance. During normal work these conveyor units convey the coal, or ore from the location where it is mined outside the shaft. Circumstances like debris falling on the conveyor units may lead to a load on the conveyor segments. When extracting the conveyor segments from the shaft the debris may will be stacked on the conveyor segments and is at least partially also transported outside the shaft. To avoid problems or even damage to the launching unit, the guide frame or other equipment outside the shaft the guide frame preferably also comprises a deflector unit for sideways deflection of debris transported by the conveyor segments.

A further preferred embodiment provides support means for vertical support of the guide frame against the high wall. These support means are adapted to exert (pass on) horizontal forces towards the high wall. These forces may generated by several different actions undertaken by either the guide frame or the launch unit, like the retracting of the conveyor units when mining in the shaft has ended and the conveyor units have to be retracted to be used for other purposes.

This embodiment can be implemented by letting the support means be at least two beams, each hinged connected to a side of the frame, wherein at the distal ends of the beams pressure distributing (spreading) elements have been provided, which pressure distributing elements are adapted to support with a substantial surface against the high wall. The length of these beams is preferably variable for easy installing the support means. This leads to a relative simple construction which can easily be adapted to the situation wherein it is used. Preferably the joints are universal joints.

While employing the method according the invention it is also an option to release the guide frame sideways over the conveyor segments for service or emergency purposes and/or the landing the cutterhead to the launch unit.

The present invention will be further elucidated with reference to the non-limitative embodiments shown in the following figures, in which:

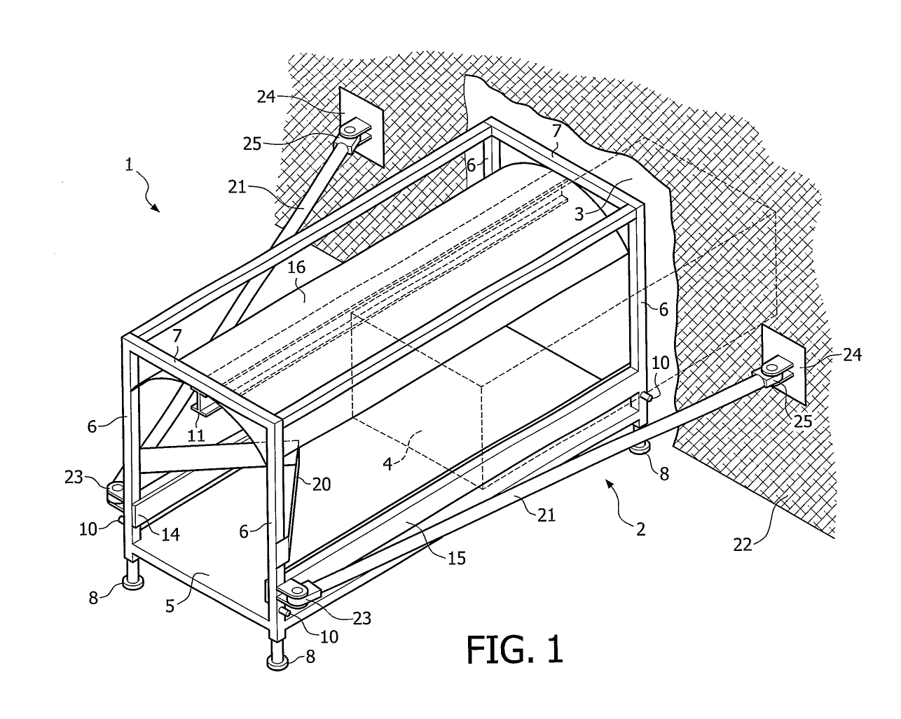

FIG. 1 shows a perspective diagram of a guide frame according to the invention;

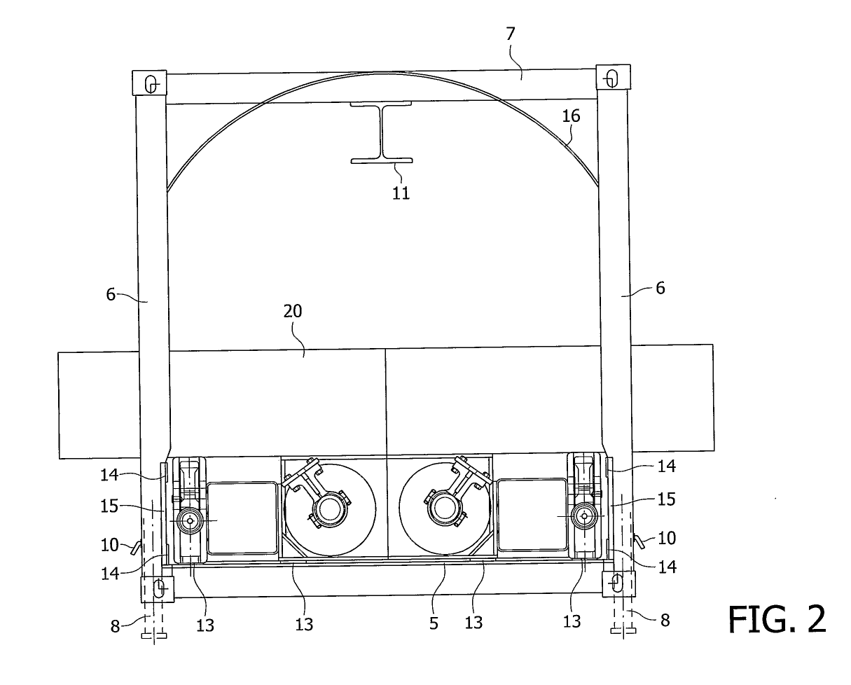

FIG. 2 shows a cross sectional view of an embodiment of a guide frame; and

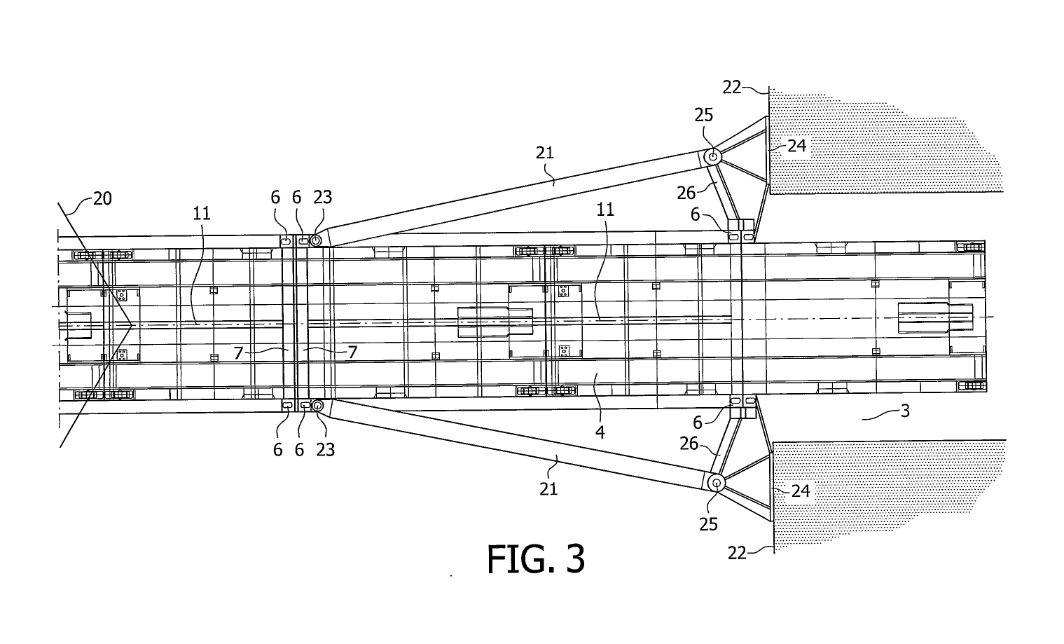

FIG. 3 shows a plan view of the guide frame depicted in FIG. 2.

In FIG. 1 a guide frame denoted in its entirety as 1 is shown. The guide frame 1 is adapted to be located between the entrance 2 of a shaft 3 and a launching vehicle (not shown) in high wall mining operations.

The guide frame 1 comprises a rectangular ground plate 5, four stiles 6 located at each of the comers of the ground plate 5 and connection beams 7 connecting the upper ends of the stiles 6. The stiles 6 are hollow profiles and under each of said profiles a jack 8 is movable in vertical direction. Commonly these jacks 8 extend downward from the ground plate 5 (also indicated as the bottom area), wherein they bear the weight of the guide frame 1. The jacks 8 can be fixed relative to the ground plate 5 by pin and hole connections 10. The guide frame 1 comprises a beam 11 connecting both connection beams 7. Although not explicitly shown the guide 1 frame may comprise means for connection with the launch vehicle.

A function of the guide frame 1 is the guiding of conveyor segments 4 during their travel into the shaft 3 and from the shaft 3. Although gliding of the conveyor segments 4 over the safety grip gated ground plate 5 is not excluded it is preferable to use horizontal slide plates 13 (not referred to in FIG. 1) over which the conveyor segments 4 can slide. The slide plates 13 are referred to in FIG. 2. The location of the slide plates 13 is dependant from the construction of the conveyor segments 4; care must be taken that the conveyor segments 4 only contact the slide plates 13 to avoid undue wear of the ground plate 5. Herein it is emphasized that the mining operations cause a lot of loose hard materials which may lead to excessive wear, which is avoided by using slide plates 13 of wear resistant material.

During the mining operations lateral forces may develop which could lead to lateral displacements of the conveyor segments 4. To keep these lateral displacements limited the guide frame 1 also comprises lateral slide plates 14. These slide plates 14 are attached to a profile 15 extending in the longitudinal direction of the guide frame 1. It is noted that the guide frame 1 is high relative to the commonly limited height of the conveyor segments 4. The room resulting from this difference in height may be used as work room to let employees conduct maintenance work on the conveyor segments 4. Therefore a roof 16 has been provided to offer employees a safe work room, e.g. when starting a new shaft 3 of when retracting the cutter head from the shaft 3. The beam 11 which functions as constructional part may then also be used as a hoist rail to make hoist operations possible, for instance to exchange defect parts of the conveyor segments 4.

The conveyor segments 4 are not only used to push the cutter head into the shaft 3, but also to remove the substance excavated by the cutter head like coal, ore and mine stone out of the shaft 3. To fulfill this function the conveyor segments 4 comprise augers, transport belts or other conveyors. The material (e.g. material from the mine roof) fallen on the conveyor segments 4 and carried out of the shaft 3 may even extend above the height of the conveyor segments 4. When this high loaded material reaches the launching vehicle it may damage the launching vehicle. To avoid the material laying on top of the conveyor segments 4 reaching the launching vehicle, the guide frame 1 comprises a material deflector 20 having the shape of an arrow point. It serves to deflect material being conveyed above the conveyor segments 4 sideways from the guide frame 1, from where it can be carrier away. This deflector 20 is clearly depicted in FIGS. 2 and 3.

Another function of the guide frame 1 resides in the conduction of forces e.g. exerted by a launching vehicle. A situation wherein these forces may develop is during the withdrawal of the conveyor segments 4 and the cutter head from the shaft 3. The forces needed to withdraw the train of conveyor segments 4 can reach substantial values requiring anchoring of the launching vehicle 4. An easy way of anchoring is the provision of supporting means of the guide frame 1 to the high wall in which the mine shaft 3 is excavated. Therefore the guide frame 1 is swivable connected with two beams 21, one at each side of the guide frame, of which the distal end is adapted to be supported against the high wall 22. The connection with the guide frame 1 is by a hinge 23 with a vertical axis. This hinge 23 may be replaced by a ball joint allowing an extra degree of freedom. The distal ends of the beams 21 is also swivably connected with a support plate 24 via joints 25, which support plate 24 is adapted to be supported against the high wall. This arrangement allows the passage of longitudinal forces. To be able to transmit also lateral forces both the distal ends of the beams 21 and the support plates 24 are connected with the guide frame 1 through substantial lateral rods 26. Herein it is noted that the lateral forces which can be absorbed by the support plates 24 is limited as these forces are dependant on the friction between the support plates 24 and the high wall.

The cross section of the frame 1 may be dimensioned to be equal to the cross sectional dimensions of a standard sea container to allow easy transportation. Transport is further enhanced by providing the corners of the guide frame 1 with apertures fit (“corner castings”) for engagement by normal fixation means for sea containers.

FIG. 1 shows a guide frame 1 which is implemented in a single container unit, for instance a unit with a length of 40 ft. It is however also possible to use several containers when the situation dictates so. An embodiment wherein a guide frame is thus subdivided is shown in FIG. 3. The material deflector 20 and the connection with the beams 21 may be on the same container but these facilities may also be distributed over different containers. Lengths of standard sea containers are commonly multiples of 10 ft, so that it is advantageous when the length of the total guide frame is a multiple of 10 ft to allow an easy implementation in units with the dimensions of standard sea containers.

1. Guide frame (1) for use in high wall mining to be located between a launching apparatus and the entrance (2) of a shaft (3) in a high wall (22) and adapted to guide conveyor segments (4) between the launch unit and the shaft (3), comprising a substantial horizontal supporting guide (5, 13) for supporting the conveyor segments (4).

2. Guide frame (1) as claimed in claim 1, wherein the guide frame (1) comprises uprights (6), that the distance between the uprights (6) in the direction perpendicular to the direction of movement of the conveyor segments (4) is larger than the width of the conveyor segments (4) and that the guide frame (1) comprises a beam (11) connecting upper cross beams (7) at opposite ends of the frame (1).

3. Guide frame (1) as claimed in claim 1, further comprising adjustment means (8, 21, 24) for adjusting the elevation and the tilt of the supporting guide (5,13).

4. Guide frame (1) as claimed in claim 3, wherein at each of the corners of the guide frame (1) adjustment means (8) have been provided.

5. Guide frame (1) as claimed in claim 1, wherein the size of the cross section of the guide frame (1) is equal to the size of the cross section of a standard container.

6. Guide frame (1) as claimed in claim 5, wherein the length of the guide frame (1) is a multiple of 10 feet.

7. Guide frame (1) as claimed in claim 2, wherein at the top of the guide frame (1) a roof (16) has been provided.

8. Guide frame (1) as claimed in claim 1, wherein the guide frame (1) comprises a deflector unit (20) for sideways deflection of debris placed on top of the conveyor segments (4).

9. Guide frame (1) as claimed in claim 1, further comprising support means (21, 24, 26) for vertical support of the guide frame (1) against the high wall (22).

10. Guide frame (1) as claimed in claim 9, wherein the support means (21, 24) comprise at least two beams (21, 26), each connected to a side of the frame (1), wherein at the distal ends of the beams (21, 26) pressure distributing elements (24) have been provided, which pressure distributing elements (24) are adapted to support against the high wall (22).

11. Method for high wall mining comprising the following steps:
arranging a launch unit opposite a location of a high wall (22) wherein a shaft (3) is to be excavated;
excavating the shaft (3) by a cutter head; and
inserting conveyor segments (4) as the cutter head progresses into the high wall (22),
wherein a guide frame (1) is arranged between the high wall (22) and the launch unit before the cutter head starts excavating.

12. Method as claimed in claim 11, wherein the position of the guide frame (1) is adjusted before start of excavation.

13. Method as claimed in claim 11, wherein the guide frame (1) is sideways released over the conveyor segments (4).
